(19) United States
(12) Patent Application Publication
(10) Pub. No.: US 2005/0083061 A1
(43) Pub. Date: Apr. 21, 2005

(54) Methods and systems for estimating formation resistivity that are less sensitive to skin effects, shoulder-bed effects and formation dips

(76) Inventors: Jacques R. Tabanou, Houston, TX (US); Hanming Wang, Sugar Land, TX (US); Dzevat Omeragic, Sugar Land, TX (US)

Correspondence Address: Schlumbereger Oilfield Service, P.O. Box 2175, Houston, TX, 77252-2175, US

(21) Appl. No.: 10/688,280

(22) Filed: Oct. 17, 2003

(51) Int. Cl. G01V 3/08

(52) U.S. Cl. 324/334

(57) ABSTRACT

A method for determining an electrical property of a formation includes acquiring a first resistivity measurement by energizing a first transmitter and receiving a first signal in a first receiver, wherein the first transmitter and the first receiver are disposed on the logging tool in a first orientation substantially parallel to a longitudinal axis of the logging tool; acquiring a second resistivity measurement by energizing a second transmitter and receiving a second signal in a second receiver, wherein the second transmitter and the second receiver are disposed on the logging tool in a second orientation that is substantially orthogonal to the first orientation; and deriving the electrical property of the formation from a difference measurement that is derived from the first resistivity measurement and the second resistivity measurement.

### BACKGROUND OF THE INVENTION

1. Field of the Invention

The invention relates generally to well logging using resistivity logging tools. More particularly, the invention relates to methods and systems for reliable determination of formation conductivities.

2. Background Art

Electromagnetic (EM) induction logging instruments are well known in the art. These instruments are used to determine the electrical properties (conductivity, or its converse, resistivity) of earth formations penetrated by a wellbore. Measurements of formation conductivities may be used to estimate the fluid contents of the earth formations because hydrocarbon-bearing earth formations are associated with lower conductivity (higher resistivity).

Physical principles of EM induction logging are described in, H. G. Doll, “Introduction to Induction Logging and Application to Logging of Wells Drilled with Oil Based Mud,” Journal of Petroleum Technology, vol. 1, p. 148, Society of Petroleum Engineers, Richardson Tex. (1949). Since then, many improvements and modifications to EM induction logging instruments have since been devised. For example, U.S. Pat. No. 3,510,757 issued to Huston and assigned to the assignee of the present invention discloses an EM logging instrument equipped with transverse antennas for measuring formation relative dips. U.S. Pat. No. 6,304,086 B1 issued to Minerbo et al. and assigned to the assignee of the present invention discloses EM logging instruments for evaluating formation resistivities in high-contrast thin layers or formations with high dip angles.

In a conventional EM logging instrument, the transmitter and receiver coils (antennas) have their magnetic dipoles substantially aligned with the longitudinal axis of the instrument. The antennas on these tools are referred to as longitudinal magnetic dipoles (LMD) antennas. With an LMD tool, eddy currents are induced in the earth formations to flow in ground loops that are substantially perpendicular to the axis of the tool. The eddy currents then induces secondary magnetic fields that in turn generate voltages in the receiver antennas. The magnitudes of the detected signals relate to the magnitudes of the eddy currents, which in turn relate to the formation conductivities. Certain earth formations, however, consist of thin layers of electrically conductive materials interleaved with thin layers of substantially non-conductive material. In these situations, the responses (signals) received by a receiver of an LMD induction instrument will be dominated by the eddy currents flowing in the conductive layers. In contrast, less-conductive layers will have less or little contribution to the overall responses. Consequently, non-conductive layers are often missed using the conventional LMD logging tools despite the fact that they are hydrocarbon-bearing.

To overcome this problem, new EM induction instruments typically include transmitter and/or receiver antennas that have their magnetic dipoles substantially perpendicular to the axis of the instrument. These antennas are referred to as transverse magnetic dipole (TMD) antennas. The TMD antennas induce eddy currents to flow in loops parallel to the tool axis. Thus, the eddy currents flow through various layers in a vertical well. In this manner, the sedimentation layers act like resistors in series in the eddy current loops. Therefore, the signals (voltages) received by a TMD tool is more affected by the more resistive layers—i.e., the hydrocarbon-bearing layers.

Examples of TMD instruments include tri-axial induction instruments that have three transmitter antennas arranged in orthogonal orientations and three receiver antennas oriented in the corresponding orthogonal orientations. In a tri-axial induction tool energized in three orthogonal directions, individual receiver coils aligned in the same three orthogonal directions measure the voltages induced by eddy currents flowing in the surrounding formations. The implementation of tri-axial antennas, for example, may be found in U.S. Pat. No. 3,510,757 issued to Huston and U.S. Pat. No. 5,781,436 issued to Forgang et al.

Tri-axial induction logging instruments can provide improved evaluation of heterogeneous rock formations. In addition to being able to locate thin hydrocarbon-bearing layers, these tools can also provide improved estimation of hydrocarbon reserves in anisotropic reservoirs. Examples of anisotropic reservoirs (or formations) include highly-laminated formations. These formations can be characterized by two electrical parameters: the resistivity parallel to the bedding designated as Rₕ and the resistivity perpendicular to the bedding designated as Rᵥ. When wells are drilled in reservoirs that may include anisotropic sedimentation layers, it is important for the operators to be able to quickly estimate (preferably in real time while the data is being acquired) the degree of anisotropy of a particular zone in order to make sure that the well is following the planned path or stay within the pay zone.

Although tri-axial or TMD instruments can provide improved measurements for the evaluation of formation resistivity, the raw measurements provided by these instruments, like those obtained with LMD tools, are affected by skin effects, environmental effects, shoulder-bed effects, and formation relative dips.

Skin effects are characterized by non-linear responses of the received signals in relation to the formation conductivities. Skin effects result primarily from interactions between eddy currents flowing in adjacent loops in the formation. The magnitudes of skin effects depend on a complicated function of the coil system operating frequency, the effective length of the antenna system, and the conductivity value of the adjacent formation, among other things.

Shoulder-bed effects result from eddy currents that flow in sedimentation layers lying above and/or below the layer being investigated. The shoulder-bed effects are particularly problematic if the layer under investigation is less conductive than the adjacent beds. In this case, the conductive adjacent beds will have significant (or dominant) contribution in the received signals.

To some extent, the skin effects and the shoulder-bed effects can be mitigated by tool designs and logging parameters. For example, U.S. Pat. No. 2,582,314 issued to Doll and U.S. Pat. No. 3,067,383 issued to Tanguy disclose induction tools having multiple transmitter and receiver coils arranged in specific relationships to “focus” the sonde response function by narrowing the width of the main lobe and attenuating the side-lobes. In an alternative approach, U.S. Pat. No. 2,790,138 issued to Poupon discloses an induction logging tool having two separate induction coil arrangements, which have the same geometrical center so that responses from the two coil arrangements may be used to cancel the contributions from the side-lobes.

In addition to tool design, signal processing methods have been developed to improve measurement accuracy by reducing skin effects and shoulder-bed effects. Examples of signal processing approaches include phasor processing disclosed in U.S. Pat. No. 4,513,376 issued to Barber and U.S. Pat. No. 4,471,436, issued to Schaefer et al. In addition, U.S. Pat. Nos. 4,818,946 and 4,513,376 issued to Barber disclose methods of processing the induction log measurements to reduce the unwanted contributions in the log measurements by minimizing the side-lobes in the sonde response function used to correlate the voltage measurements with true formation conductivity. The sonde response function is known as a vertical sensitivity curve of the induction tool. Furthermore, U.S. Pat. No. 6,304,086 B1 issued to Minerbo et al. also discloses a tool and a new processing method (the Grimaldi processing) that can provide measurements with minimal skin effects and shoulder-bed effects. In addition, this tool can output in real time an estimate of Rᵥ. and Rₕ in an anisotropic formation.

Although prior art tools and methods can produce good resistivity estimates, there is still a need for new methods for formation resistivity evaluation that are insensitive to insensitive to skin effects, shoulder-bed effects, and formation relative dips.

### SUMMARY OF INVENTION

One aspect of the invention relates to methods for determining an electrical property of a formation using at least two sets of orthogonal resistivity measurements. A method for determining an electrical property of a formation in accordance with the invention includes acquiring a first resistivity measurement by energizing a first transmitter and receiving a first signal in a first receiver, wherein the first transmitter and the first receiver are disposed on the logging tool in a first orientation substantially parallel to a longitudinal axis of the logging tool; acquiring a second resistivity measurement by energizing a second transmitter and receiving a second signal in a second receiver, wherein the second transmitter and the second receiver are disposed on the logging tool in a second orientation that is substantially orthogonal to the first orientation; and deriving the electrical property of the formation from a difference measurement that is derived from the first resistivity measurement and the second resistivity measurement

One aspect of the invention relates to methods for estimating an anisotropic resistivity ratio of an anisotropic formation. A method for estimating an anisotropic resistivity ratio of an anisotropic formation in accordance with the invention includes acquiring a first resistivity measurement by energizing a first transmitter and receiving a first signal in a first receiver, wherein the first transmitter and the first receiver are disposed on the logging tool in a first orientation substantially parallel to a longitudinal axis of the logging tool; acquiring a second resistivity measurement by energizing a second transmitter and receiving a second signal in a second receiver, wherein the second transmitter and the second receiver are disposed on the logging tool in a second orientation that is substantially orthogonal to the first orientation; and deriving the anisotropic resistivity ratio from a ratio of the first resistivity measurement and the second resistivity measurement.

One aspect of the invention relates to methods for estimating an anisotropic resistivity ratio of an anisotropic formation. A method for estimating an anisotropic resistivity ratio of an anisotropic formation in accordance with the invention includes acquiring a first resistivity measurement by energizing a first transmitter and receiving a first signal in a first receiver, wherein the first transmitter and the first receiver are disposed on the logging tool in a first orientation substantially parallel to a longitudinal axis of the logging tool; acquiring a second resistivity measurement by energizing a second transmitter and receiving a second signal in a second receiver, wherein the second transmitter and the second receiver are disposed on the logging tool in a second orientation that is substantially orthogonal to the first orientation; and deriving the anisotropic resistivity ratio from a ratio of the first resistivity measurement and the second resistivity measurement.

One aspect of the invention relates to systems for determining an electrical property of a formation. A system for determining an electrical property of a formation in accordance with the invention includes a computer having a memory storing a program having instructions for: acquiring a first resistivity measurement by energizing a first transmitter and receiving a first signal in a first receiver, wherein the first transmitter and the first receiver are disposed on the logging tool in a first orientation substantially parallel to a longitudinal axis of the logging tool; acquiring a second resistivity measurement by energizing a second transmitter and receiving a second signal in a second receiver, wherein the second transmitter and the second receiver are disposed on the logging tool in a second orientation that is substantially orthogonal to the first orientation; and deriving the electrical property of the formation from a difference measurement that is derived from the first resistivity measurement and the second resistivity measurement.

Other aspects and advantages of the invention will be apparent from the following description and the appended claims.

### BRIEF DESCRIPTION OF DRAWINGS

FIG. 1 shows a prior art well logging system.

FIG. 2 shows a simple two tri-axial antenna tool that can be used with embodiments of the invention.

FIG. 3 shows the skin effects on various measurements derived from a tri-axial measurements according to one embodiment of the invention.

FIG. 4 shows vertical geometrical factors of various measurements according to one embodiment of the invention.

FIG. 5 shows the radial geometrical factors of various measurements according to one embodiment of the invention.

FIG. 6 shows integrated radial geometrical factors of various measurements according to one embodiment of the invention.

FIG. 7 shows formation conductivities derived from various measurements in a stair-case formation model having no relative dip according to one embodiment of the invention.

FIG. 8 shows formation conductivities derived from various measurements in a stair-case formation model having a 60-degree relative dip according to one embodiment of the invention.

FIG. 9 shows formation conductivities derived from various measurements in a stair-case formation model having a 90-degree relative dip according to one embodiment of the invention.

FIG. 10 shows formation conductivities derived from various measurements in the Oklahoma 2 formation having no relative dip according to one embodiment of the invention.

FIG. 11 illustrates better bed boundary definition using a difference measurement according to one embodiment of the invention.

FIG. 12 shows vertical geometrical factors of various measurements according to one embodiment of the invention.

FIG. 13 shows formation conductivities derived from various measurements in a stair-case formation model having no relative dip according to one embodiment of the invention.

FIG. 14 shows a cross plot for determining anisotropic ratio of a formation according to one embodiment of the invention.

FIG. 15 shows a flowchart of a method in accordance with one embodiment of the invention.

FIG. 16 shows a prior art computer that can be used with embodiments of the invention.

### DETAILED DESCRIPTION

Embodiments of the present invention relate to methods and systems for estimating conductivity of rock formations. Specifically, the present invention is directed to methods and systems that can provide consistent and accurate conductivity measurements that are less sensitive to skin and shoulder-bed effects, regardless of the relative dips of the formation bedding. The conductivities obtained using embodiments of the present invention may include an apparent conductivity, and a conductivity parallel or perpendicular to the formation bedding. In addition, the present invention provides a method for estimating the anisotropic resistivity ratio in anisotropic formations.

In the following description, the term “conductivity” is used interchangeably with “resistivity” because one is the reciprocal of the other and either can be used to characterize the electrical properties of a material. In addition, the description uses induction logging as an example. However, one of ordinary skill in the art would appreciate that embodiments of the invention may also be applied to orthogonal sets of measurements obtained from propagation logging. Therefore, both induction and propagation measurements are expressly within the scope of the invention. Furthermore, methods of the invention may also be used to process previously acquired measurements that include two sets of orthogonal measurements, i.e., reprocessing of existing data. Thus, any reference to logging or data-acquisition steps in this description is only for illustration and is not intended to limit every embodiment of the invention.

Embodiments of the present invention relate to methods for probing a rock formation using at least two orthogonal sets of induction measurements. The at least two orthogonal sets of induction measurements are obtained by energizing two transmitters having their magnetic dipoles in orthogonal directions (e.g., one parallel to and the other perpendicular to the tool axis) and receiving the induced signals (voltages) in two receivers having their magnetic dipoles oriented in the same directions as the transmitter magnetic dipoles. For example, the first transmitter and receiver pair have their magnetic dipoles aligned with the tool axis (i.e., longitudinal magnetic dipole (LMD) antennas), and the second transmitter and receiver pair have their magnetic dipoles perpendicular to the tool axis (i.e., transverse magnetic dipole (TMD) antennas). One of ordinary skill in the art would appreciate that the orthogonal sets of induction measurements may be acquired using any induction logging tool equipped with at least one transmitter and at lest one receiver, each including an LMD and a TMD antennas. Examples of the antenna arrangements may include a tri-axial array, which includes a tri-axial transmitter and a tri-axial receiver. In this description, a transmitter or a receiver may include a single coil (antenna) or a group of coils arranged in a set. For example, a tri-axial transmitter or a tri-axial receiver includes three coils arranged in orthogonal directions. While preferred embodiments of the invention use orthogonal antennas that are either parallel or perpendicular to the tool axis, orthogonal antennas that deviate from these orientations (i.e., tilted antennas) may also be used.

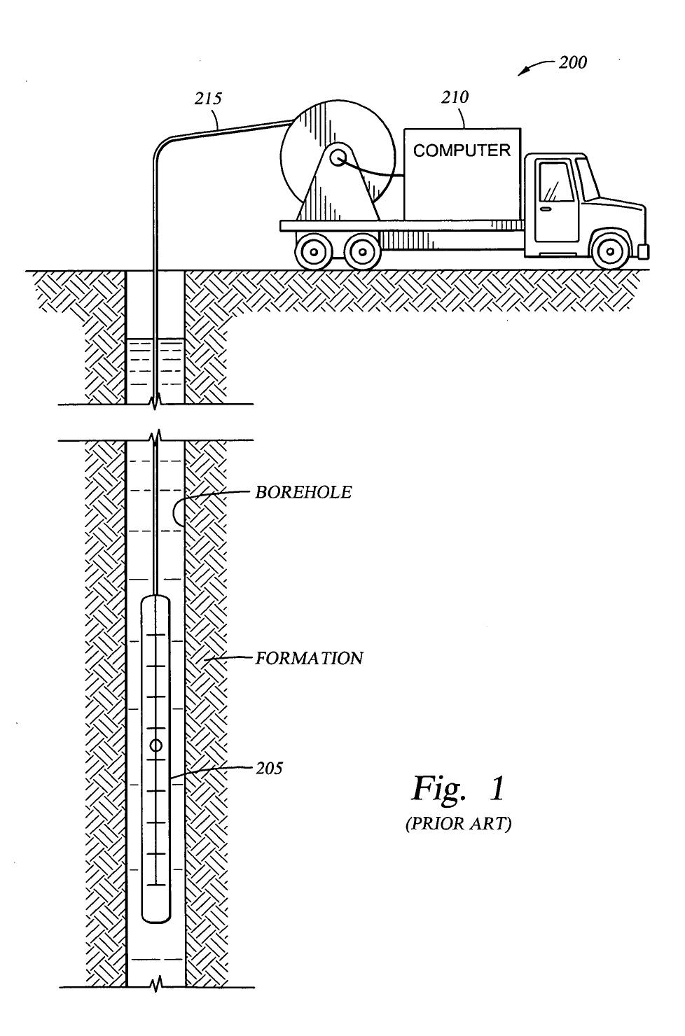

FIG. 1 shows a schematic of a typical logging system. Certain conventional details are omitted in FIG. 1 for clarity of illustration. The logging system 200 includes a logging tool 205 adapted to be moveable through a borehole. The logging tool 205 is connected to a surface equipment 210 via a wireline 215 (or drill string). Although a wireline tool is shown, those skilled in the art would appreciate that embodiments of the invention may be implemented in wireline or while-drilling (LWD or MWD) operations. The surface equipment 210 may include a computer.

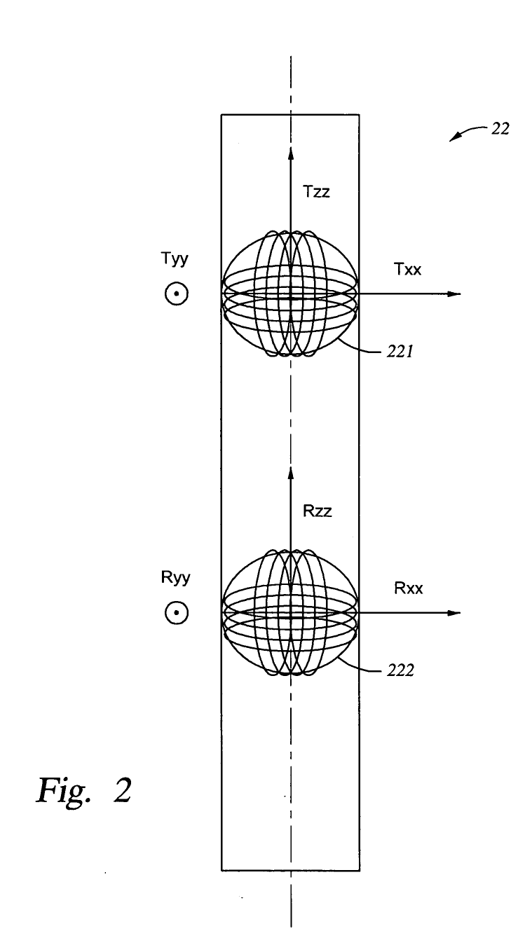

The logging tool 205 may be any conventional induction tool capable of providing two orthogonal measurements, e.g., a tri-axial array logging tool that includes a tri-axial transmitter and a tri-axial receiver. FIG. 2 shows an exemplary induction tool 220 having a tri-axial array. As shown, the induction tool 220 includes a tri-axial transmitter 221 and a tri-axial receiver 222. One of ordinary skill in the art would appreciate that an antenna may be used as a transmitter or receiver. Therefore, specific reference to transmitter or receiver antennas in this description is only for clarity of illustration. Furthermore, while a co-located tri-axial array, in which the centers of the three antenna coils are co-located, is shown, one of ordinary skill in the art would appreciate that other antenna configurations may also be used.

For clarity, the following description assumes that the tool has a single transmitter and a single receiver, as shown in FIG. 2. However, a typical resistivity tool may have more than one transmitter and/or more than one receiver. A transmitter or a receiver as used herein may include one or more coils arranged in a group, such as a tri-axial transmitter or a tri-axial receiver. Furthermore, a set of “bucking” coils may be included between each pair of the transmitter and the receiver to reduce the mutual couplings between them. The bucking coils typically include the same number of coils as that of the receiver coils, and the bucking coils are wound in opposite direction to those of the corresponding receiver coils.. One of ordinary skill in the art would appreciate that embodiments of the invention are not limited by any specific configuration of the resistivity logging tool as long as the tool is capable of providing two orthogonal measurements of resistivity.

In accordance with embodiments of the invention, the first set of measurements may be made using the transmitter and receiver antennas (coils) having their magnetic dipoles aligned with the tool axis (z-axis). These antennas, which are traditionally referred to as longitudinal magnetic dipole (LMD) antennas, are referred to as “T_{zz}” for the transmitter and “R_{zz}” for the receiver in FIG. 2. When T_{zz} is energized, it induces eddy currents to flow in the formations in the xy planes, i.e., perpendicular to the tool axis (z-axis). The eddy currents flowing in the xy planes would induce a voltage V_{zz} in the receiver R_{zz}, whose magnetic dipole is also aligned with the z-axis.

A second set of measurements may be made using transmitter and receiver antennas having their magnetic dipoles perpendicular to the tool axis—i.e., along the x-axis or y-axis. These transmitter and receiver antennas are traditionally referred to as transverse magnetic dipole (TMD) antennas. They are referred to as “Tₓₓ” or “T_{yy}” for the transmitter and “Rₓₓ” or “R_{yy}” for the receiver in FIG. 2. When transmitter Tₓₓ is energized, it induces eddy currents to flow in planes perpendicular to the x-axis, e.g., in the yz planes. These eddy currents then induce a voltage Vₓₓ in the receiver Rₓₓ, the magnetic dipole of which is aligned with the same x-axis direction. One of ordinary skill in the art would appreciate that the description for Vₓₓ applies equally well to V_{yy}, which is acquired with a transmitter and a receiver both having their magnetic dipoles in the y-axis direction. Furthermore, any description about Vₓₓ or V_{yy} applies equally well to an average (or a weighted average) of Vₓₓ and V_{yy}.

The induced voltages (signals) V_{zz} and Vₓₓ are proportional to quantities shown in equation (1) and (2).

$${V}_{zz} = K ( 1 - ⅈ k L ) ( 1 + ⅈ k L - \frac{1}{2} {k}^{2} {L}^{2} - \frac{ⅈ}{6} {k}^{3} {L}^{3} ) \\ or \\ {V}_{zz} = K ( 1 + \frac{1}{2} {k}^{2} {L}^{2} - \frac{ⅈ}{3} {k}^{3} {L}^{3} + … ) \qquad ( 1 )$$

Vₓₓ=iKe^{ikL}(−1+ikL+k²L²) ( 2)
where

$$K = \frac{ω μ}{4 π {L}^{3}} ,$$

is the transmitter-receiver spacing, and k is the wave number. In the low frequency limit with negligible dielectric effect, the wave number k may be defined as:

$$k = \sqrt{ⅈωμσ} = \frac{1 + ⅈ}{δ} \qquad ( 3 )$$

where δ is the skin effect, which is a function of the operation frequency (ω=2πf), magnetic permeability of the medium (μ), and the conductivity of the medium (σ):

$$δ = \sqrt{\frac{2}{ωμσ}} \qquad ( 3 a )$$

As can be seen from equation (3a), the skin effect (δ) is a function of the tool operation frequency (ω). If the operating frequency (ω) is not too high, then the skin effect may not be significant. If the skin effect (δ) is not significant relative to the transmitter-receiver spacing (L) (i.e., L/δ<1), then the skin effect is only a perturbation to the measurements. Under these conditions, taking the difference between the induced voltages V_{zz} (equation (1)) and Vₓₓ (equation (2)), yields equation (4) or (5):

$${V}_{zz} - {V}_{xx} = K ( 3 ⅈ + \frac{ⅈ}{2} {k}^{2} {L}^{2} + \frac{- 1}{6} {k}^{5} {L}^{5} ) \qquad ( 4 )$$

or,

$${V}_{zz} - {V}_{xx} = 3 - \frac{1}{12} {( ωμσ )}^{\frac{5}{2}} {L}^{5} + ⅈ ( ωμσ {L}^{2} - \frac{1}{12} {( ωμσ )}^{\frac{5}{2}} {L}^{5} ) \qquad ( 5 )$$

The real part of equation (4) is proportional to the formation conductivity, σ.

$$ℜ ( {V}_{zz} - {V}_{xx} ) = ωμσ {L}^{5} ( 1 - \frac{1}{12} {( ωμσ )}^{\frac{3}{2}} {L}^{3} ) \qquad ( 6 )$$

Equation (6) shows that the real part of (V_{zz}−Vₓₓ) is proportional to a with an error term proportional to

$${( \frac{L}{δ} )}^{3} .$$

Therefore, the real part of (V_{zz}−Vₓₓ) shown in equation (6) provides a measurement of formation conductivity that is much less affected by the skin effect (δ). In comparison, V_{zz}, which is conventionally used to derive the classical σ_{zz}, has an error term proportional to

$$( \frac{L}{δ} )$$

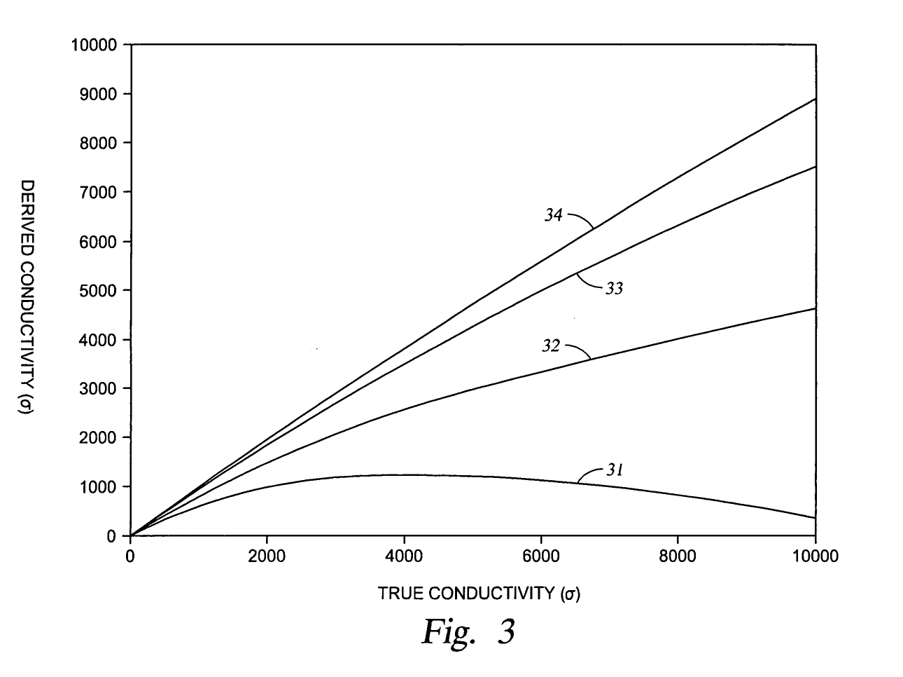

and, therefore, is more affected by the skin effect (δ). Thus, the real part of (V_{zz}−Vₓₓ) should be able to provide more reliable determinations of the formation conductivities. This is illustrated in FIG. 3.

FIG. 3 shows correlations between true conductivity of a homogeneous medium and the derived conductivities based on various measurements obtained using a typical resistivity logging tool equipped with at least one LMD antenna and at least one TMD antenna, for example a tri-axial resistivity tool. Curve 31 shows conductivities derived from Vₓₓ measurements; curve 32 shows conductivities derived from V_{zz} measurements; curve 33 shows conductivities derived from Re(V_{zz})−Im(Vₓₓ); and curve 34 shows conductivities derived from V_{zz}−Vₓₓ. It is known that a transverse measurement (e.g., Vₓₓ) is more sensitive than a longitudinal measurements (e.g., V_{zz}) to skin effects. This is seen by greater deviation from the expected values in curve 31 (Vₓₓ) than in curve 32 (V_{zz}).

Curve 33, which is based on Re(V_{zz})−Im(Vₓₓ), has less skin effects than either curve 31 (Vₓₓ) or curve 32 (V_{zz}). This is because some skin effects are cancelled out in the difference measurements. It is known that the imaginary part of a signal correlates with the skin effect and that Vₓₓ suffers more from skin effects. Therefore, the Im(Vₓₓ) term provides a good skin effect correction and, thus, the difference measurement Re(V_{zz})−Im(Vₓₓ) is expected to have less skin effects. What is surprising is that the difference measurement V_{zz}−Vₓₓ is the least affected by the skin effects (see curve 34), even less than the Re(V_{zz})−Im(Vₓₓ) measurement (curve 33).

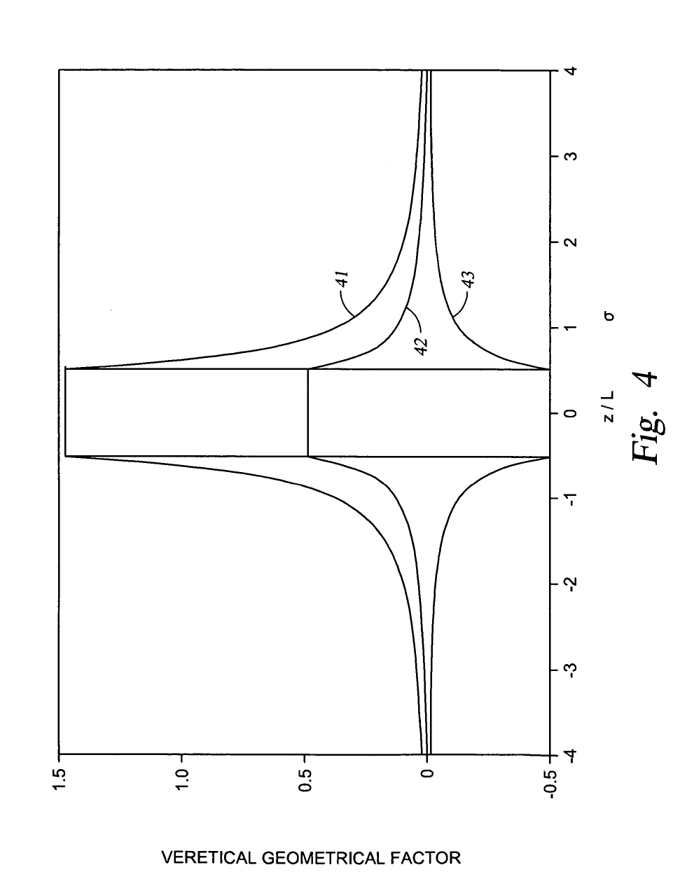

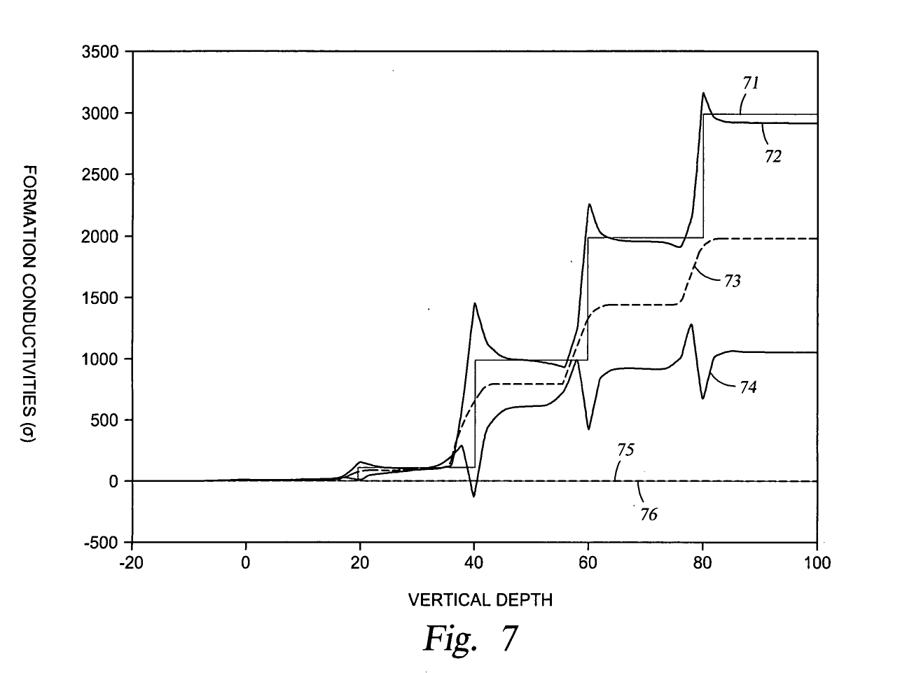

In addition to being less affected by skin effects, the difference measurement (V_{zz}−Vₓₓ) is also less affected by the shoulder-bed effects. FIG. 4 shows the vertical geometric factors as a function of z/L (where z is the vertical distance from the center of the antennas and L is the transmitter-receiver spacing) for the V_{zz}, Vₓₓ and V_{zz}−Vₓₓ measurements. Curve 41 is the vertical geometrical factor for the Vₓₓ measurement. Because Vₓₓ measures signals induced by eddy currents flowing in yz planes, this measurement is expected to be influenced by sedimentation layers lying above and below the vertical location of the antennas, hence more shoulder-bed effects. Curve 42 shows the vertical geometrical factor for the V_{zz} measurement. Because the V_{zz} measurements detect eddy currents flowing in the xy planes, they are expected to have less shoulder-bed effects as compared with the Vₓₓ measurement. Curve 43 shows the vertical geometrical factor for the V_{zz}−Vₓₓ measurement. Clearly, the V_{zz}−Vₓₓ measurement (curve 43) has less shoulder-bed effects than either the V_{zz} (curve 42) or the Vₓₓ (curve 41) measurement. The improved geometrical factor is another advantage of the difference measurement, V_{zz}−Vₓₓ, as compared with the V_{zz} or the Vₓₓ measurement. The results shown in FIG. 4 is also consistent with resistivity profiles derived from these measurements, shown in FIGS. 7-9 to be described later.

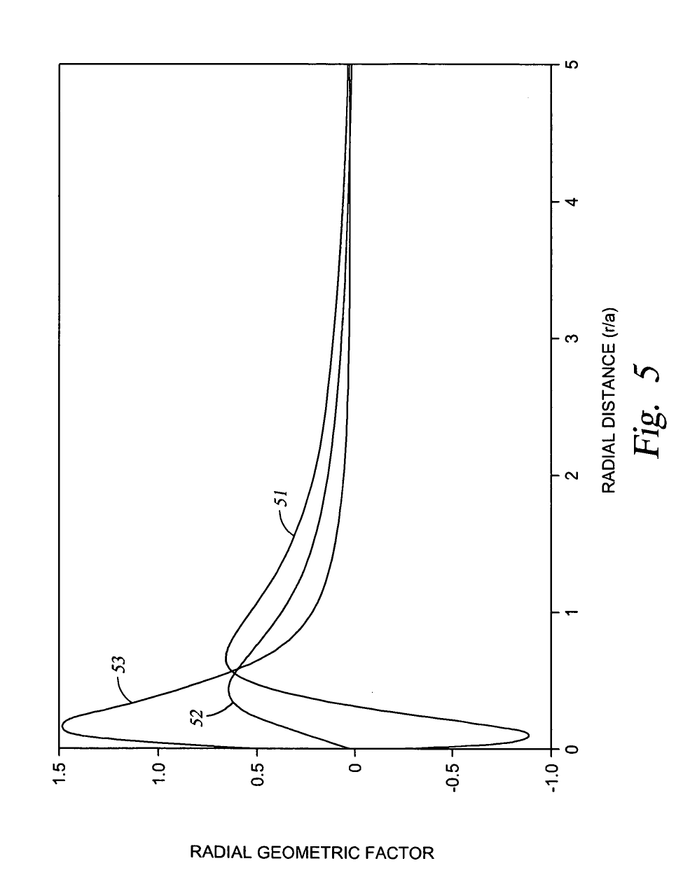

FIG. 5 shows the radial geometrical factors for the Vₓₓ, V_{zz}, and V_{zz}−Vₓₓ measurements as a function of r/a (r is the radial distance into the formation and a is the radius of the tool). It is clear that the radial response profile of the difference measurement, V_{zz}−Vₓₓ (curve 53), is shallower than either the V_{zz} (curve 52) or the Vₓₓ (curve 51) measurement. A shallow radial response profile is associated with a better vertical resolution. Therefore, the difference measurement V_{zz}−Vₓₓ is expected to have a better vertical resolution than either the V_{zz} measurement or the Vₓₓ measurement, consistent with the results shown in FIG. 4.

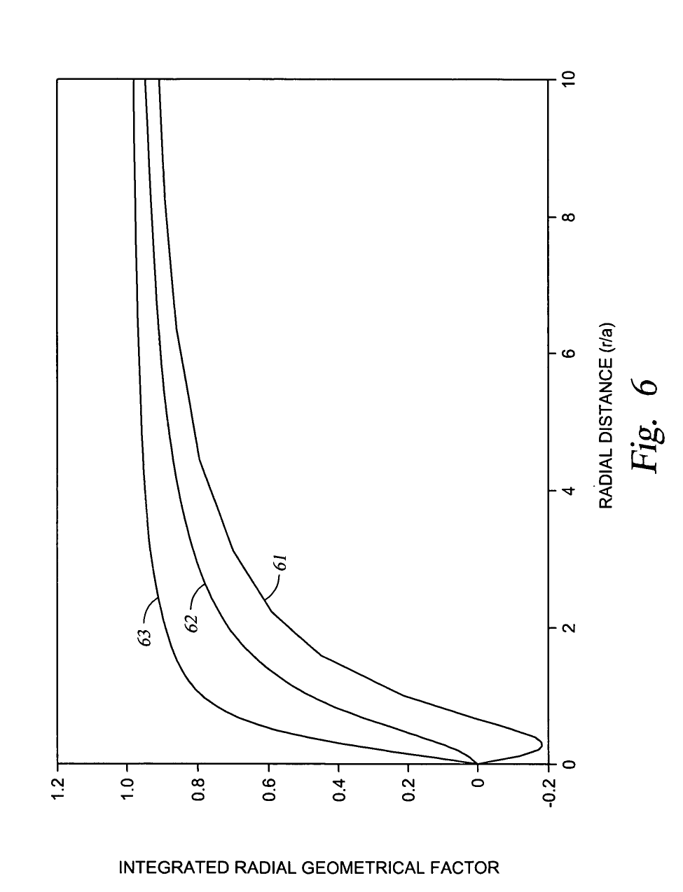

FIG. 6 shows the integrated radial geometrical factors for the Vₓₓ, V_{zz}, and V_{zz}−Vₓₓ measurements as a function of r/a. The integrated radial geometrical factors show that the difference measurement V_{zz}−Vₓₓ (curve 63) is shallower than the V_{zz} measurement (curve 62). However, the difference measurement V_{zz}−Vₓₓ (curve 63) behaves better (no negative values) than the Vₓₓ measurement (curve 61) in the near wellbore region.

The above description shows that the difference measurement V_{zz}−Vₓₓ has less skin effects, less shoulder-bed effects, and a better vertical resolution, when compared with either the Vₓₓ measurement or the V_{zz} measurement. These properties of the V_{zz}−Vₓₓ measurement predict that the V_{zz}−Vₓₓ difference measurement should be able to provide better estimates of true formation resistivities and more precise bed boundaries.

FIGS. 7-9 show tool responses based on various measurements to a staircase resistivity profile in a formation model. The tool has a 27 in. transmitter-receiver spacing. FIG. 7 shows the formation conductivities as derived from various measurements in a formation with no relative dip. As shown, the difference measurements V_{zz}−Vₓₓ (curve 72) produce conductivity estimates that closely match the true values (curve 71), i.e., with minimum skin effects and shoulder-bed effects. In comparison, the traditional LMD measurements, V_{zz} (curve 73), produce estimates that are substantially lower than the true conductivities due to the skin effects. In addition, the V_{zz} measurement (curve 73) also show more shoulder-bed effects. The skin effects and shoulder-bed effects are even more severe in the TMD measurements, Vₓₓ or V_{yy} (curve 74). FIG. 7 also shows the cross-coupling measurements V_{xz} (curve 75) and V_{zx} (curve 76), which do not have measurable signals in this vertical well in a homogeneous formation. It is clear from FIG. 7 that the difference measurements V_{zz}−Vₓₓ (curve 72) produce significantly better estimates than do either the V_{zz} (curve 73) or the Vₓₓ (curve 74) measurements.

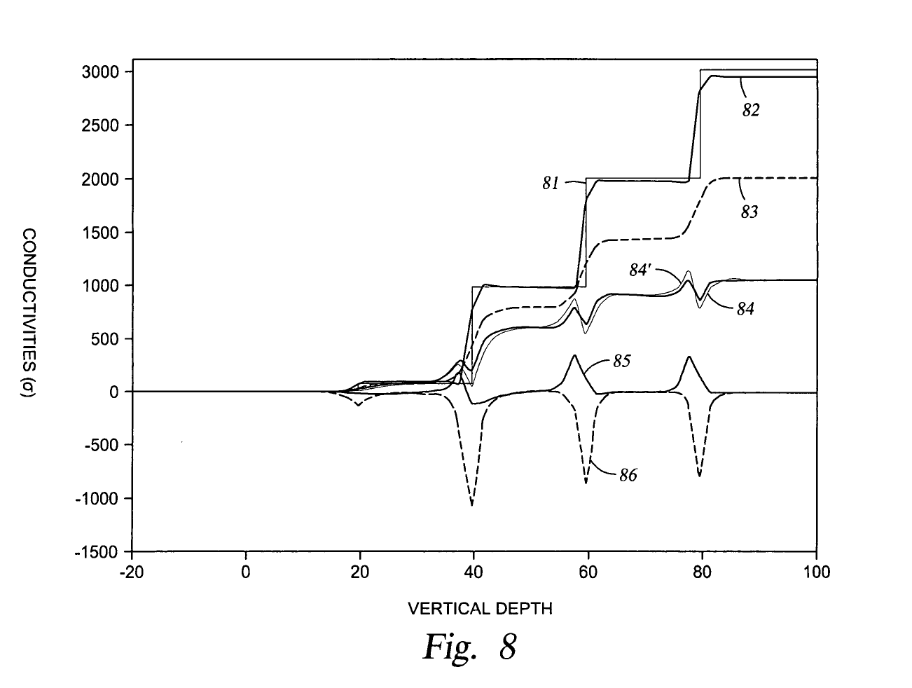

FIG. 8 shows the formation conductivities as derived from various measurements in formations with a 60-degree relative dip. As shown, the difference measurements V_{zz}−Vₓₓ (curve 82) produce conductivity estimates that closely match the true values (curve 81), i.e., with minimum skin effects and shoulder-bed effects. In addition, the estimated values from V_{zz}−Vₓₓ measurements seem insensitive to relative dips; this is apparent from a comparison between curve 72 in FIG. 7 and curve 82 in FIG. 8. Again, the V_{zz} measurements (curve 83) are more affected by the skin effects and the shoulder-bed effects. The skin effects and shoulder-bed effects are even more severe in the Vₓₓ (curve 84) or the V_{yy} (curve 84′) measurements. FIG. 8 shows that the cross-coupling measurements V_{xz} (curve 85) and V_{zx} (curve 86) are now measurable at bed boundaries. Again, FIG. 8 shows that the difference measurements V_{zz}−Vₓₓ (curve 82) produce significantly better estimates (i.e., less skin effects and less shoulder-bed effects) than either of the V_{zz} (curve 83), Vₓₓ (curve 84), or V_{yy} (curve 84′) measurements.

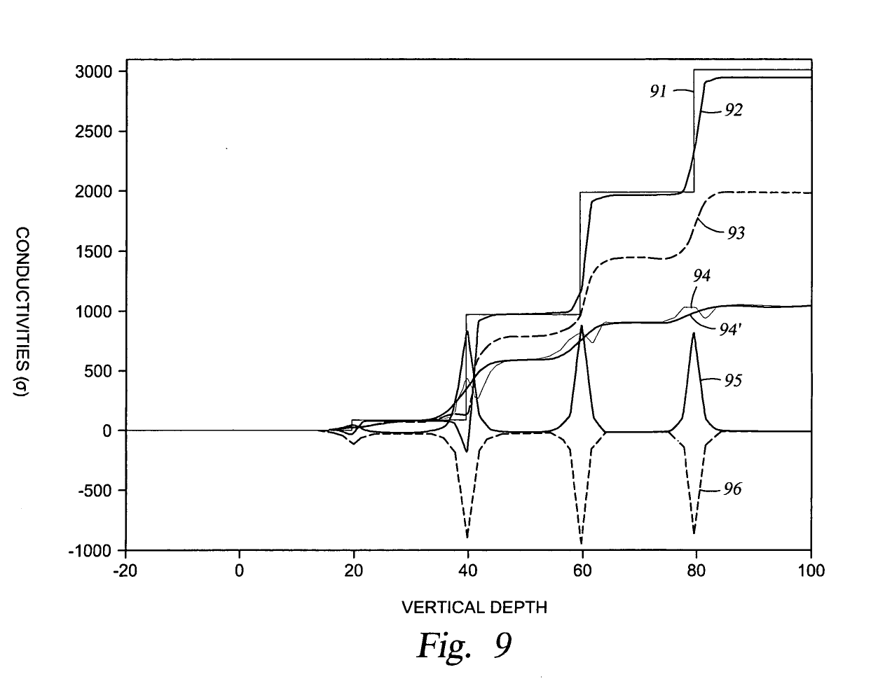

FIG. 9 shows the formation conductivities as derived from various measurements in formations with a 90 -degree relative dip, e.g., a horizontal well. The difference measurements V_{zz}−Vₓₓ (curve 92) produce conductivity estimates that closely match the true values (curve 91) even in this highly deviated well. This confirms that the V_{zz}−Vₓₓ measurements are insensitive to relative dips. In contrast, the V_{zz} measurements (curve 93) are influenced by the skin effects and the shoulder-bed effects. The skin effects and shoulder-bed effects are even more severe in the Vₓₓ (curve 94) or V_{yy} (curve 94′) measurements. The cross coupling measurements V_{xz} (curve 95) and V_{zx} (curve 96) do not produce reliable estimates of the formation conductivities.

FIGS. 7-9 clearly show that the difference measurements V_{zz}−Vₓₓ produce significantly better conductivity/resistivity estimates than do either the V_{zz} or Vₓₓ measurements. Furthermore, the difference measurements V_{zz}−Vₓₓ also provide better definition of bed boundaries (or boundary contrasts) because these measurements provide sharper resistivity/conductivity changes at bed boundaries.

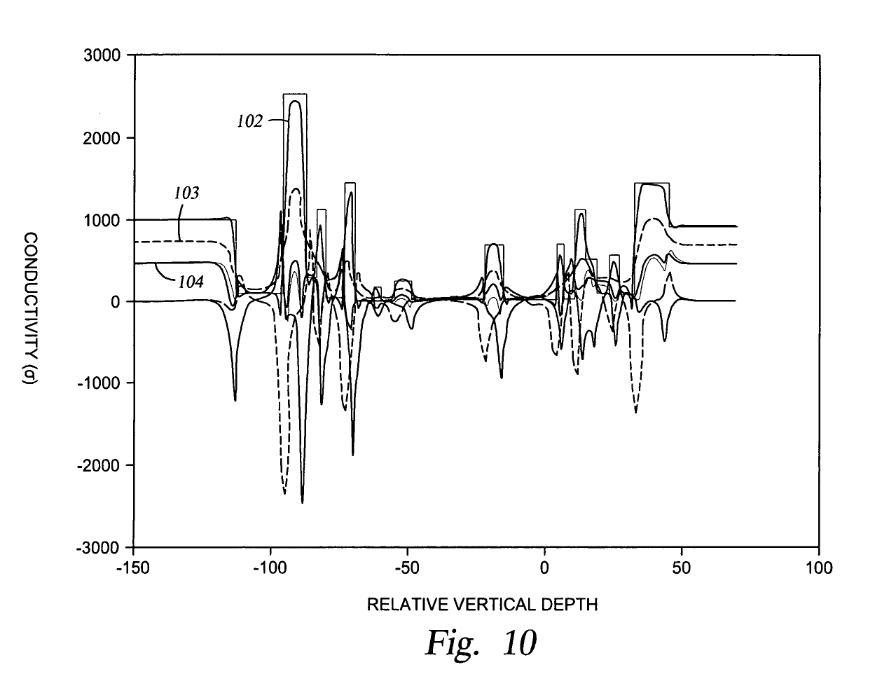

The better definition of bed boundaries and better estimates of the resistivity in each layer makes it possible to provide better weight for each detected boundary, i.e., more accurate weight that is proportional to the contrast between the adjacent beds. The better resistivity estimates and boundary definition obtained from V_{zz}−Vₓₓ may serve as inputs for the inversion of more complex data sets, such as those obtained with tri-axial arrays. More importantly, the difference measurements V_{zz}−Vₓₓ can produce reliable estimates regardless of the formation dips. These advantages of the V_{zz}−Vₓₓ measurements have also been observed in real formations, e.g., the Oklahoma 2 test formation (FIG. 10).

FIG. 10 shows the conductivities derived from various measurements in the Oklahoma 2 test formation. As shown the V_{zz}−Vₓₓ measurement (curve 102) has significantly less skin effects and shoulder-bed effects than the V_{zz} measurement (curve 103) and the Vₓₓ measurement (curve 104).

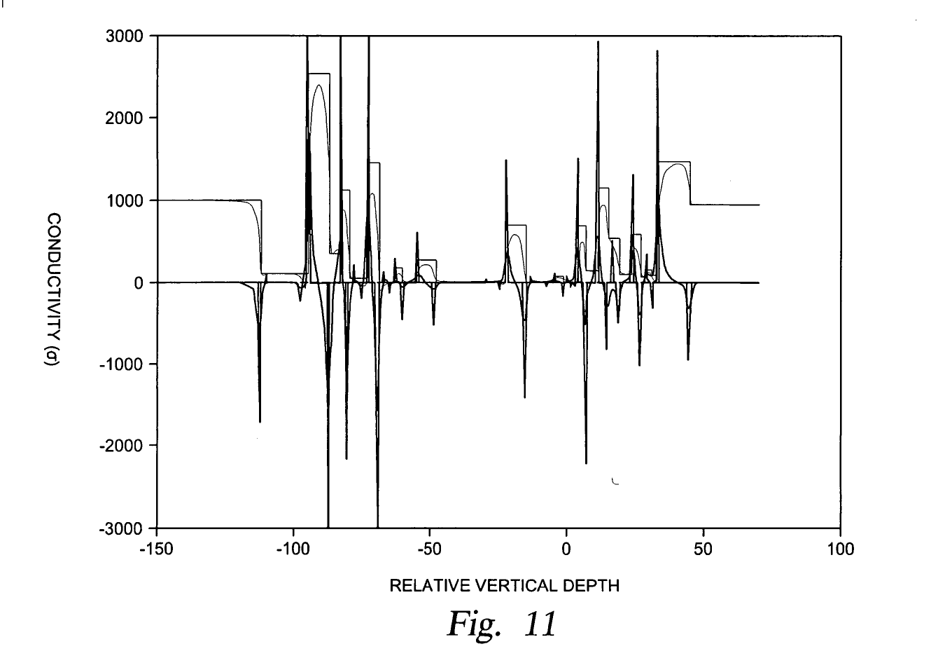

As noted above, in addition to providing more accurate estimates of the conductivity, the V_{zz}−Vₓₓ measurement also provides better defined bed boundaries. FIG. 11 shows that the bed boundaries can be accurate identified from the inflection points of the V_{zz}−Vₓₓ curves—e.g., by taking the derivatives of the curve. Because the resistivity/conductivity derived from V_{zz}−Vₓₓ measurements in each bed is more accurate and because the V_{zz}−Vₓₓ measurements provide better definition of bed boundaries, the V_{zz}−Vₓₓ measurements can provide more reliable inputs (initial estimates) for the inversion of full tri-axial induction measurements, hence speeding up the inversion process.

The above description shows that a simple difference measurement, V_{zz}−Vₓₓ, can provide an improved estimate of formation resistivity with less skin effects and shoulder-bed effects. However, FIG. 3 also shows that the vertical geometrical factor of the V_{zz}−Vₓₓ measurements is not perfect. Therefore, further improvement should be possible. The geometric factor approach has been used to further improve the resistivity estimates according to a general formation: α(βV_{zz}−Vₓₓ), where α and β are constants. With this approach, it was found that the difference function 1/2(3/2V_{zz}−Vₓₓ) provides an optimal vertical geometrical factor.

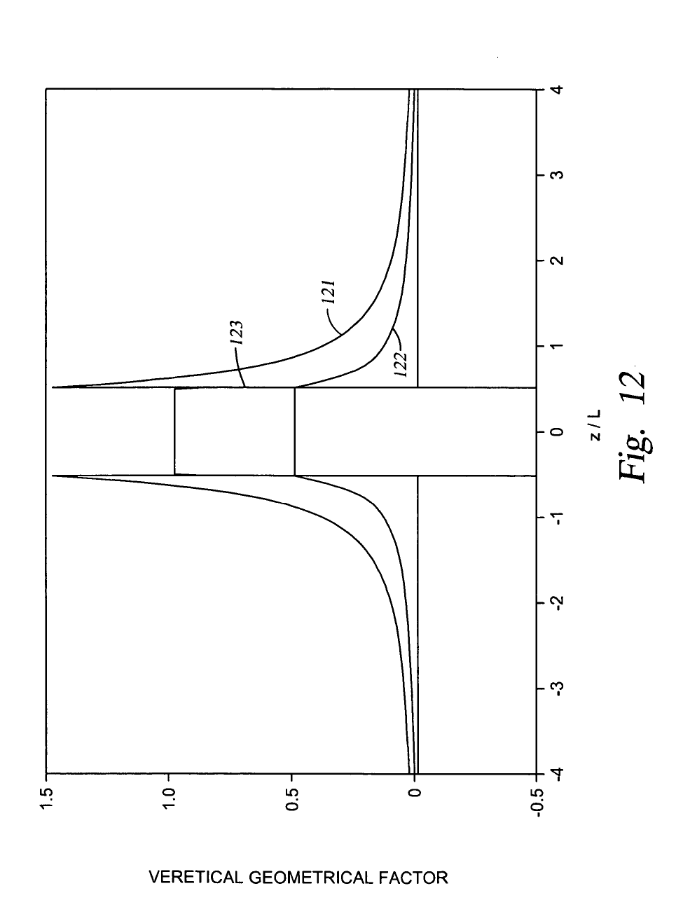

FIG. 12 shows the geometrical factor of the 1/2(3/2V_{zz}−Vₓₓ) measurements (curve 123) as compared with the V_{zz} (curve 121) and Vₓₓ (curve 122) measurements. It is clear that the shoulder-bed effects essentially disappear in the difference measurements 1/2(3/2V_{zz}−Vₓₓ).

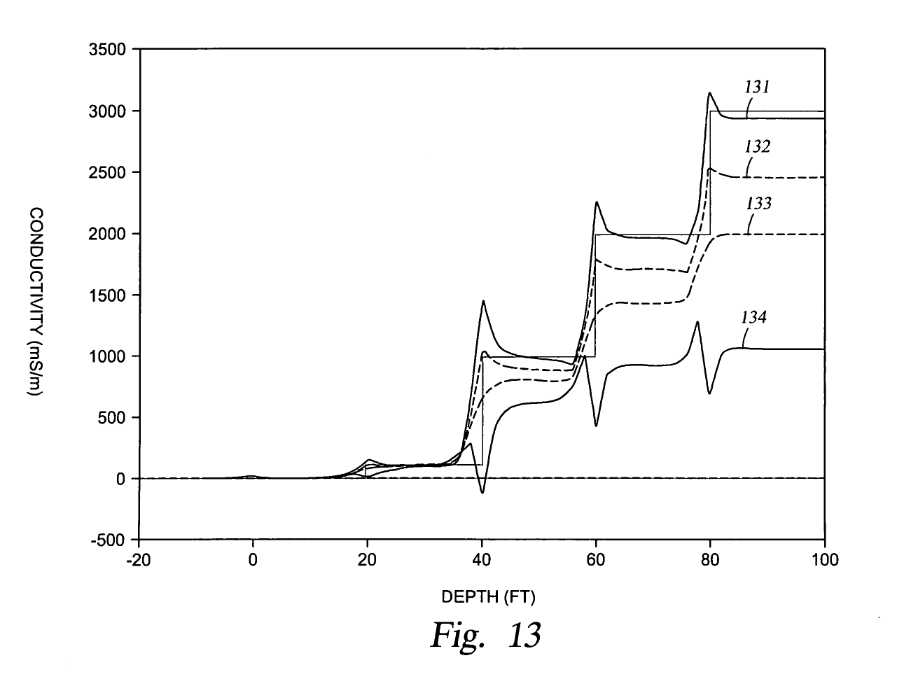

FIG. 13 shows the conductivities derived from various measurements in a stair-case resistivity model formation. A comparison between the V_{zz}−Vₓₓ measurements (curve 131) and the 1/2(3/2V_{zz}−Vₓₓ) measurements (curve 132) reveals that the 1/2(3/2V_{zz}−Vₓₓ) measurements have less should-bed effects, but more skin effects. Both the V_{zz}−Vₓₓ measurements (curve 131) and the 1/2(3/2V_{zz}−Vₓₓ) measurements (curve 132) provide better estimates than the V_{zz} measurements (curve 133) or the Vₓₓ measurements (curve 134). The same phenomena are also observed in a vertical well in the Okalahoma 2 formations (data not shown). Thus, either the V_{zz}−Vₓₓ or the 1/2(3/2V_{zz}−Vₓₓ) measurement, or their variants, can provide better formation resistivity estimates than the conventional V_{zz} measurements. The choice between the V_{zz}−Vₓₓ measurement and the 1/2(3/2V_{zz}−Vₓₓ) measurement will depend on whether one is more concerned with the skin effects or the shoulder-bed effects.

Some embodiments of the invention provide more reliable estimates of the horizontal and vertical resistivities in anisotropic formations. In a formation with a low relative dip, if the logging operation is performed with low frequencies (i.e., negligible skin effects), the real part of the V_{zz} measurements is proportional to the formation conductivity in the horizontal planes, σₕ, while the real part of the Vₓₓ measurements is proportional to the formation conductivity in the vertical direction, σᵥ. Various methods have been reported for deriving the σₕ and σᵥ values from the V_{zz} and Vₓₓ measurements. However, the σₕ and σᵥ values thus derived are not always accurate because the V_{zz} and Vₓₓ measurements are sensitive to the skin effects and the shoulder-bed effects. In addition, the V_{zz} and Vₓₓ measurements are sensitive to the relative dips.

It is found that the ratio of the real parts of these two measurements, V_{zz}/2Vₓₓ, is approximately proportional to the square of the anisotropy coefficient (λ²), i.e.,

$$\frac{{V}_{zz}}{2 {V}_{xx}} ≅ \frac{{σ}_{h}}{{σ}_{v}} = \frac{{R}_{v}}{{R}_{h}} \qquad ( 7 )$$

Therefore, if the horizontal conductivity (σₕ) can be estimated, then the vertical conductivity (σᵥ) can be derived from the V_{zz}/2Vₓₓ ratio and the estimated σₕ.

According to embodiments of the present invention, the V_{zz}−Vₓₓ measurements can be used to derive accurate estimates of σₕ. The σₕ thus obtained can then be used to derive the σᵥ from the estimated σₕ and the V_{zz}/2Vₓₓ ratio. As noted above, the resistivities derived from the V_{zz}−Vₓₓ measurements are less sensitive to skin effects and shoulder-bed effects. Therefore, the estimates of σₕ and σᵥ thus derived are more reliable.

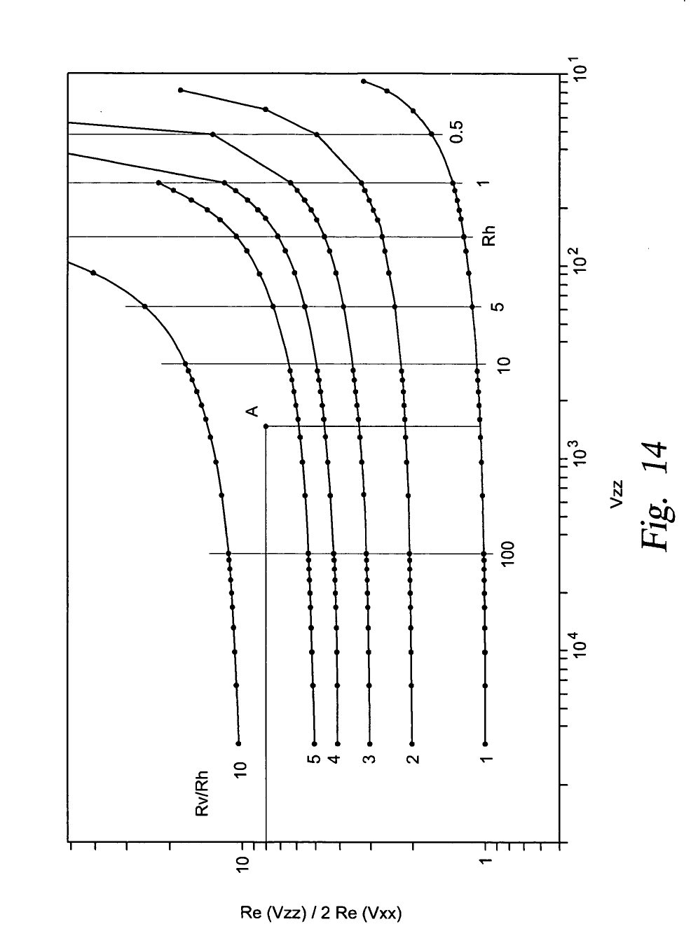

FIG. 14 shows a cross plot of Re(Vₓₓ)/2Re(V_{zz}) versus Re(V_{zz}) that can be used to estimate the Rᵥ/Rₕ ratio for low relative dip formations. Each curve in the plot corresponds to a different Rᵥ/Rₕ ratio. These curves may be obtained from simulation. To use this plot to obtain the anisotropy ratio and the Rₕ, a point corresponding to the Re(Vₓₓ)/2Re(V_{zz}) and Re(V_{zz}) values is located on the chart (e.g., point A shown in FIG. 14). A vertical line is then drawn from point A to estimate the Rₕ value (hence, πₕ). A horizontal line is drawn from point A to estimate the corresponding Rᵥ/Rₕ ratio. Once the Rᵥ/Rₕ ratio and the Rₕ value are available, Rᵥ can then be determined.

Thus, the new measurements V_{zz}−Vₓₓ and V_{zz}/2Vₓₓ according to embodiments of the invention can provide extremely useful information in the inversion of full tri-axial induction measurements. These measurements provide three important parameters: the precise bed boundary location, an approximate initial guess to the inversion algorithm and an initial guess for the anisotropy ratio Rᵥ/Rₕ. The more accurate estimates can speed up the inversion process.

The above approach to estimating Rᵥ/Rₕ from the V_{zz} and Vₓₓ measurements is feasible only when there is no or minimal dip. Some embodiments of the invention relate to method for providing reliable resistivity estimates in anisotropic formations even when the formations have significant relative dips.

Effects of formation anisotropy on resistivity measurements in a homogeneous anisotropic formation were first described by Moran and Gianzero. See Moran and Ginzero, “Effect of Formation Aniostropy on Resistivity Anisotropy measurements,” Geophysics, Vol. 44, pp. 1266-1286, (1979). The equations for anisotropic formation resistivity calculations derived by Moran and Ginzero are referenced to a coordinate system tied to the formation layers. Because resistivity measurements may be acquired with tools not perpendicular to the formation layers (e.g., a formation with relative dips), these equations are often difficult to apply. In U.S. Pat. No. 6,584,408 issued to Omeragic (“the Omeragic patent”) and assigned to the assignee of the present invention, these equations were simplified to a reference frame relative to the logging tool. This patent is incorporated by reference in its entirely. The Omeragic patent discloses a procedure for determining anisotropic formation parameters from tri-axial measurements in formations with relative dips. According to one procedure, the horizontal conductivity (πₕ) of the formation is first determined from the tri-axial measurements by using cross coupling terms. Then, the dip angle (α) is derived from the measurements and the estimated σₕ. Finally, the vertical conductivity (σᵥ) of the formation is derived from the horizontal resistivity (σₕ) and the dip (α).

The method disclosed in the Omeragic patent first derives the horizontal conductivity (σₕ) from coupling terms in tri-axial measurements by solving the following equation: (T′_{zz}−Lₕ)(T′ₓₓ−Tₕ)=(T_{xz})². As noted above, the horizontal conductivity (σₕ) of a formation may be more reliably obtained from the V_{zz}−Vₓₓ measurements regardless of the relative dips. Therefore, the horizontal conductivity (σₕ) may be more conveniently obtained from the difference measurement (V_{zz}−Vₓₓ).

Once the horizontal conductivity (σₕ) is available, the dip angle (α) can be determined according to the following equation that is disclosed in the Omeragic patent:

$$α = {tan}^{- 1} \frac{{T}_{xz}^{′}}{{T}_{h} - {T}_{xx}^{′}} \qquad ( 8 )$$

where T′ₓₓ and T′_{zz} are the strike-rotated xx (Vₓₓ′) and xz couplings (V_{xz}′), and Tₕ is the xx coupling (Vₓₓ) in an isotropic formation having a conductivity σₕ. The term “strike-rotated” means that the reference coordinate system has been rotated to remove the strike (azimuthal angle) of the dipping plane. The process of removing strike from the measurements is disclosed in the Omeragic patent. An alternative to obtaining the relative angle (α) is to use:

$$α = {tan}^{- 1} \frac{{L}_{h} - {T}_{zz}^{′}}{{T}_{xz}^{′}} \qquad ( 9 )$$

where T′_{zz} is the strike-rotated zz coupling (V_{zz}′), and Lₕ is the zz coupling (V_{zz}) in an isotropic formation having a conductivity σₕ.

Equations (8) and (9) may be combined using the formula for the sum of tan⁻¹ to give:

$$α = 0.5 {tan}^{- 1} \frac{{T}_{xz}^{′2} ( {L}_{h} - {T}_{zz}^{′} ) ( {T}_{h} - {T}_{xx}^{′} )}{{T}_{h} - {L}_{h} + {T}_{zz}^{′} - {T}_{xx}^{′}} \qquad ( 10 )$$

or,

$$α = 0.5 {tan}^{- 1} \frac{2 {T}_{xz}^{′}}{( {T}_{zz}^{′} - {T}_{xx}^{′} ) - ( {L}_{h} - {T}_{h} )} \qquad ( 11 )$$

Either of these two equations may be used to calculate the formation dip angles (α). However, equation (11) is more robust in extreme cases (0 or 90°), and it is undetermined (0/0) only if there is no anisotropy.

As noted above, the horizontal conductivity (σₕ) may be derived from the xz coupling (V_{xz}) or the V_{zz}−Vₓₓ measurement. Note that the horizontal conductivity (σₕ) derived from the V_{zz}−Vₓₓ measurement corresponds to the no anisotropy situation (i.e., an isotropic formation where Lₕ=Tₕ). Therefore, equation (11) cannot be used if σₕ is derived from the V_{zz}−Vₓₓ measurement. In this case, the alternative approach is to use following expression for the first guess of the relative dip,

$$α = {tan}^{- 1} \sqrt{\frac{{T}_{zz}^{′} - {L}_{h}}{{T}_{xx}^{′} - {T}_{h}}} \qquad ( 12 )$$

Once the horizontal conductivity (σₕ) and the relative (α) are available, these parameters can be used to obtain an estimate of the vertical conductivity σᵥ according to the following equation:

$${σ}_{v} = {( \frac{4 π s}{ωμ} )}^{2} \frac{{( ( 2 {T}_{h} + {L}_{h} ) - ( {T}_{xx}^{′} + {T}_{yy}^{′} + {T}_{zz}^{′} ) )}^{2}}{{σ}_{h}} \qquad ( 13 )$$

Equation (13) is simpler than the equation for deriving the σᵥ disclosed in the Omeragic patent. However, it should be noted that σ is a function of σᵥ. Therefore, the above expression should be run recursively. Furthermore, (2Tₕ+Lₕ) is proportional to σ in an isotropic formation. Therefore, equation (13) in essence derives anisotropy from the difference between the actual tool reading and what the tool would read if there is no anisotropy. The vertical conductivity (σᵥ) estimate obtained from equation (13) may then be used in an iterative solver to determine refined horizontal conductivity (σₕ) and vertical conductivity (σᵥ) from a full set of tri-axial resistivity measurements.

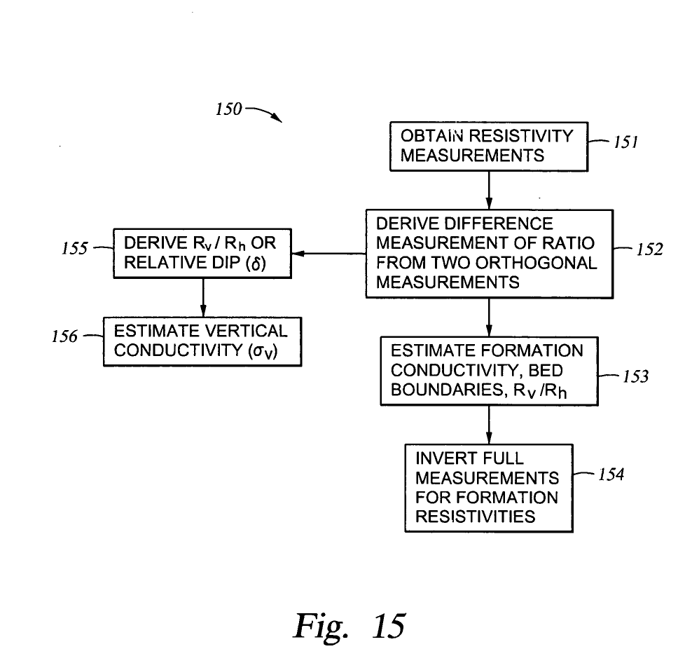

FIG. 15 shows a flowchart illustrating a method 150 in accordance with one embodiment of the invention. Initially, two orthogonal voltage measurements (e.g., V_{zz} and Vₓₓ) are obtained (Step 151). In a logging operation, these measurements will be performed at a series of depths. These measurements are typically obtained in the form of a voltage log. One of ordinary skill in the art would appreciate that the real (in-phase) parts and the imaginary (quadrature or out-of-phase) parts of the signals may be logged separately.

The two orthogonal measurements at each depth are then manipulated to obtain the desired difference measurement (V_{zz}−Vₓₓ or 1/2(3/2V_{zz}−Vₓₓ)) and/or the ratio of the measurements (V_{zz}/2Vₓₓ). (Step 152). The resulting difference measurement (V_{zz}−Vₓₓ or 1/2(3/2V_{zz}−Vₓₓ)) may be used to estimate the formation conductivity (σ) and to define the bed boundaries (Step 153). The estimated formation conductivity (σ) and the bed boundaries may be used as initial inputs for the inversion of full tri-axial measurements (step 154). As noted above, because the V_{zz}−Vₓₓ or 1/2(3/2V_{zz}−Vₓₓ) measurements provide better estimates of the formation conductivity and bed boundaries, the inversion of the full tri-axial measurements may be performed more efficiently. Particularly, the estimates derived from the difference measurements are not sensitive to formation dips. Therefore, embodiments of the invention can provide reliable formation resistivity parameters regardless of the formation relative dips.

If the formation is anisotropic, the derived formation conductivity (σ) corresponds to an initial estimate of a formation conductivity parallel to the bedding plane (σₕ). If the formation dips are not significant, the ratio (V_{zz}/2Vₓₓ) may be used to provide Rᵥ/Rₕ or the anisotropy coefficient (λ) (step 155). The anisotropy coefficient (λ) together with the estimated σₕ may then be used to derived formation relative dips (δ) and/or the formation conductivity perpendicular to the bedding planes (σᵥ) (step 156). Embodiments of the invention can provide better estimates of the horizontal conductivity (σₕ) and anisotropy coefficient (λ). Therefore, the derived parameters for the anisotropic formation are more reliable.

If the formation dips are not negligible, an alternative approach to deriving formation resistivity parameters is to estimate the horizontal conductivity (σₕ) using the V_{zz}−Vₓₓ measurements. Once the horizontal conductivity (σₕ) is known, the dip angle (α) can then be determined from a full set of tri-axial measurements according to methods described above, i.e., equations (8)-(12) (step 155). Once the horizontal conductivity (σₕ) and the dip angle (α) are available, the vertical conductivity (σᵥ) can then be determined (step 156).

Note that the above steps for deriving horizontal conductivity (σₕ) may further include using the initial estimate derived from the difference measurement in an iterative process to solve for more accurate horizontal conductivity (σₕ) using the full set of resistivity measurements (e.g., tri-axial measurements). This iterative process, if included, may be performed before the horizontal conductivity (σₕ) is used together with the Rᵥ/Rₕ ratio or the dip angle (α) to solve for the vertical conductivity (σᵥ).

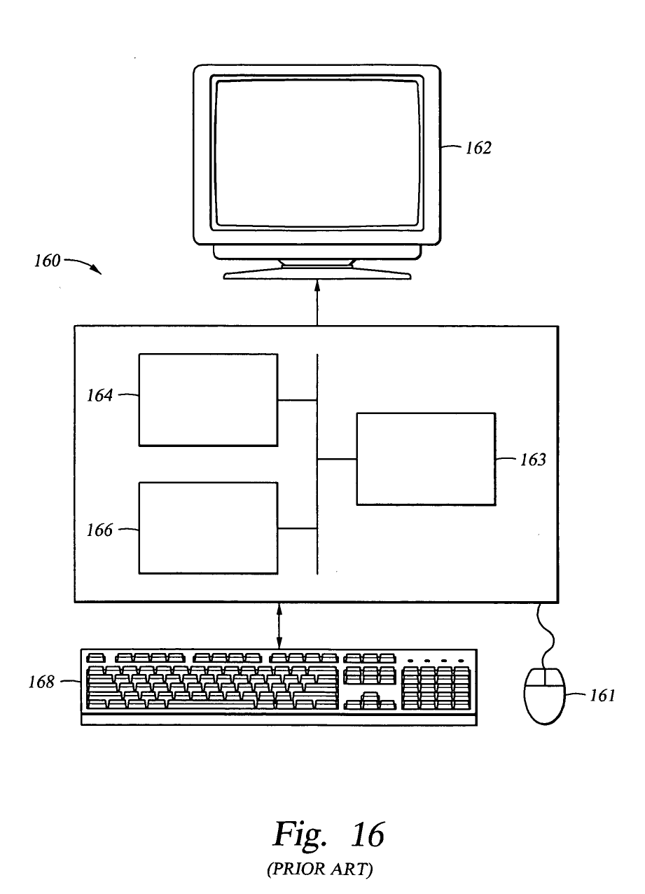

Some embodiments of the invention relate to systems for performing the methods described above. A system in accordance with embodiments of the invention may be a stand-alone unit for performing methods of the invention or may be incorporated into a drilling tool. A system in accordance with the invention typically includes a processor and a memory. In some embodiments, a system may be implemented on a general-purpose computer having a processor, a memory, and may optionally include other hardware. For example, as shown in FIG. 16, a typical computer (160) includes a processor (163), a random access memory (164), and a storage device (e.g., permanent memory or hard disk) (166). The computer (160) may also include input means, such as a keyboard (168) and a mouse (161), and output means, such as a monitor (162). Note that the general purpose computer is only for illustration and embodiments of the invention may take other forms (e.g., integrated in a logging tool).

In a system in accordance with the invention, the memory stores a program readable by the processor. The program, for example, may include instructions for performing the above described methods: obtaining resistivity measurements that include at least two orthogonal measurements (for example using a tri-axial tool), deriving difference measurements and/or a ratio of the two orthogonal measurements, estimating the formation conductivity and bed boundaries, estimating the anisotropy coefficient, deriving the horizontal and vertical conductivity of an anisotropic formation, and deriving dip angles in formations with dipping planes.

A system in accordance with the present invention provides new and improved techniques to evaluate formation electrical properties, e.g., resistivity (or conductivity), bed boundaries, anisotropy coefficient, and relative dips. The programming may be accomplished through the use of one or more program storage devices readable by the computer processor and encoding one or more programs of instructions executable by the computer for performing the operations described herein. The program storage device may take the form of, for example, one or more floppy disks, a CD-ROM or other optical disk, a magnetic tape, a read-only memory chip (ROM), and other forms of the kind well known in the art. The program of instructions may be in “object code,” i.e., in binary form that is executable directly by the computer, in “source code” that requires compilation or interpretation before execution, or in some intermediate form such as partially compiled code. The precise forms of the program storage device and of the encoding of instructions are immaterial here.

Advantages of the invention may include one or more of the following. The methods can provide more accurate estimates of formation conductivities, which are less affected by skin effects and shoulder-bed effects. In addition, the estimates are not affected by the formation dips. Therefore, reliable results may be obtained regardless of the formation dips. Furthermore, the methods of the invention also can provide more precise definition of bed boundaries. Thus, embodiments of the invention can provide more accurate initial estimates of the conductivity and bed boundaries for the inversion of full tri-axial measurements.

Some embodiments of the invention provide convenient methods for calculating the formation anisotropy coefficient. This coupled with the more reliable estimate of the horizontal conductivity of the formation makes it possible to derive more accurate vertical conductivity of the formation. In addition, some embodiments of the invention provide convenient ways to calculate formation relative dips. Thus, even in a formation with relative dips reliable estimates of anisotropic formation resistivity parameters may be derived.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for determining an electrical property of a formation, comprising:
acquiring a first resistivity measurement by energizing a first transmitter and receiving a first signal in a first receiver, wherein the first transmitter and the first receiver are disposed on the logging tool in a first orientation substantially parallel to a longitudinal axis of the logging tool;
acquiring a second resistivity measurement by energizing a second transmitter and receiving a second signal in a second receiver, wherein the second transmitter and the second receiver are disposed on the logging tool in a second orientation that is substantially orthogonal to the first orientation; and
deriving the electrical property of the formation from a difference measurement that is derived from the first resistivity measurement and the second resistivity measurement.

2. The method of claim 1, wherein the difference measurement is derived from α(βV₁−V₂), wherein α and β are constants, V₁ is the first resistivity measurement, and V₂ is the second resistivity measurement.

3. The method of claim 2, wherein α is 1 and β is 1.

4. The method of claim 2, wherein α is 1/2 and β is 3/2.

5. The method of claim 1, wherein the formation is anisotropic and the method further comprising deriving an anisotropic resistivity ratio from the first resistivity measurement and the second resistivity measurement.

6. The method of claim 5, wherein the deriving the anisotropic resistivity ratio is based on V₁/2V₂, where V₁ is the first resistivity measurement and V₂ is the second resistivity measurement.

7. The method of claim 6, wherein the derived electrical property of the formation comprises a horizontal conductivity.

8. The method of claim 7, further comprising deriving a vertical conductivity from the horizontal conductivity and the anisotropic resistivity ratio.

9. The method of claim 8, further comprising obtaining a refined horizontal conductivity and a refined vertical conductivity by using the derived horizontal conductivity and the derive vertical conductivity in an iterative solver.

10. A method for estimating an anisotropic resistivity ratio of an anisotropic formation, comprising:
acquiring a first resistivity measurement by energizing a first transmitter and receiving a first signal in a first receiver, wherein the first transmitter and the first receiver are disposed on the logging tool in a first orientation substantially parallel to a longitudinal axis of the logging tool;
acquiring a second resistivity measurement by energizing a second transmitter and receiving a second signal in a second receiver, wherein the second transmitter and the second receiver are disposed on the logging tool in a second orientation that is substantially orthogonal to the first orientation; and
deriving the anisotropic resistivity ratio from a ratio of the first resistivity measurement and the second resistivity measurement.

11. The method of claim 10, wherein the ratio is V₁/2V₂, where V₁ is the first resistivity measurement and V₂ is the second resistivity measurement.

12. A method for determining a dip angle in a formation having dipping planes, comprising:
acquiring tri-axial resistivity measurements using a tri-axial logging tool;
deriving an estimate of horizontal resistivity from a difference measurement between two orthogonal sets of measurements derived from the tri-axial measurements; and
determining the dip angle from the tri-axial resistivity measurements and the estimate of horizontal resistivity.

13. The method of claim 12, wherein the determining the dip angle is according to an equation selected from
$$\begin{matrix}α = {tan}^{- 1} \frac{{L}_{h} - {T}_{zz}^{′}}{{T}_{xz}^{′}} , \\ α = 0.5 {tan}^{- 1} \frac{{T}_{xz}^{′2} ( {L}_{h} - {T}_{zz}^{′} ) ( {T}_{h} - {T}_{xx}^{′} )}{{T}_{h} - {L}_{h} + {T}_{zz}^{′} - {T}_{xx}^{′}} , \\ α = 0.5 {tan}^{- 1} \frac{2 {T}_{xz}^{′}}{( {T}_{zz}^{′} - {T}_{xx}^{′} ) - ( {L}_{h} - {T}_{h} )} , and \\ α = {tan}^{- 1} \sqrt{\frac{{T}_{zz}^{′} - {L}_{h}}{{T}_{xx}^{′} - {T}_{h}}} ,\end{matrix}$$
wherein T′ₓₓ, T′_{zz}, and T′_{zz} are strike-rotated xx, xz, and zz couplings, respectively, and Lₕ and Tₕ are zz and xx couplings, respectively, in an isotropic formation.

14. A method for determining an electrical property of a formation from tri-axial resistivity measurements acquired with a tri-axial logging tool, comprising:
obtaining from the tri-axial resistivity measurements a first set of measurements representing couplings between a longitudinal transmitter and a longitudinal receiver;
obtaining from the tri-axial resistivity measurements a second set of measurements representing couplings between a transverse transmitter and a transverse receiver; and
deriving the electrical property of the formation from a difference measurement that is derived from the first set of measurements and the second set of measurements.

15. The method of claim 14, wherein the difference measurement is derived from α(βV₁−V₂), wherein α and β are constants, V₁ is the first set of measurements, and V₂ is the second set of measurements.

16. The method of claim 15, wherein α is 1 and β is 1.

17. The method of claim 15, wherein α is 1/2 and β is 3/2.

18. The method of claim 14, wherein the formation is anisotropic and the method further comprising deriving an anisotropic resistivity ratio from the first set of measurements and the second set of measurements.

19. The method of claim 18, wherein the deriving the anisotropic resistivity ratio is based on V₁/2V₂, where V₁ is the first set of measurements and V₂ is the second set of measurements.

20. The method of claim 19, wherein the derived electrical property of the formation comprises a horizontal conductivity.

21. The method of claim 20, further comprising deriving a vertical conductivity from the horizontal conductivity and the anisotropic resistivity ratio.

22. The method of claim 21, further comprising obtaining a refined horizontal conductivity and a refined vertical conductivity by using the derived horizontal conductivity and the derive vertical conductivity in an iterative solver.

23. A method for estimating an anisotropic resistivity ratio of an anisotropic formation from tri-axial resistivity measurements acquired with a tri-axial logging tool, comprising:
obtaining from the tri-axial resistivity measurements a first set of measurements representing couplings between a longitudinal transmitter and a longitudinal receiver;
obtaining from the tri-axial resistivity measurements a second set of measurements representing couplings between a transverse transmitter and a transverse receiver; and
deriving the anisotropic resistivity ratio from a ratio of the first set of measurements and the second set of measurements.

24. The method of claim 23, wherein the ratio is V₁/2V₂, where V₁ is the first set of measurements and V₂ is the second set of measurements.

25. A method for determining a dip angle in a formation having dipping planes from tri-axial resistivity measurements acquired with a tri-axial logging tool, comprising:
obtaining from the tri-axial resistivity measurements a first set of measurements representing couplings between a longitudinal transmitter and a longitudinal receiver;
obtaining from the tri-axial resistivity measurements a second set of measurements representing couplings between a transverse transmitter and a transverse receiver; and
deriving an estimate of horizontal resistivity from a difference measurement derived from the first set of measurements and the second set of measurements; and
determining the dip angle from the tri-axial resistivity measurements and the estimate of horizontal resistivity.

26. The method of claim 25, wherein the determining the dip angle is according to an equation selected from
$$\begin{matrix}α = {tan}^{- 1} \frac{{L}_{h} - {T}_{zz}^{′}}{{T}_{xz}^{′}} , \\ α = 0.5 {tan}^{- 1} \frac{{T}_{xz}^{′2} ( {L}_{h} - {T}_{zz}^{′} ) ( {T}_{h} - {T}_{xx}^{′} )}{{T}_{h} - {L}_{h} + {T}_{zz}^{′} - {T}_{xx}^{′}} , \\ α = 0.5 {tan}^{- 1} \frac{2 {T}_{xz}^{′}}{( {T}_{zz}^{′} - {T}_{xx}^{′} ) - ( {L}_{h} - {T}_{h} )} , and \\ α = {tan}^{- 1} \sqrt{\frac{{T}_{zz}^{′} - {L}_{h}}{{T}_{xx}^{′} - {T}_{h}}} ,\end{matrix}$$
wherein T′ₓₓ, T′_{xz}, and T′_{zz} are strike-rotated xx, xz, and zz couplings, respectively, and Lₕ and Tₕ are zz and xx couplings, respectively, in an isotropic formation.

27. A system for determining an electrical property of a formation, comprising: a computer having a memory storing a program having instructions for:
acquiring a first resistivity measurement by energizing a first transmitter and receiving a first signal in a first receiver, wherein the first transmitter and the first receiver are disposed on the logging tool in a first orientation substantially parallel to a longitudinal axis of the logging tool;
acquiring a second resistivity measurement by energizing a second transmitter and receiving a second signal in a second receiver, wherein the second transmitter and the second receiver are disposed on the logging tool in a second orientation that is substantially orthogonal to the first orientation; and
deriving the electrical property of the formation from a difference measurement that is derived from the first resistivity measurement and the second resistivity measurement.

28. The system of claim 27, wherein the difference measurement is derived from α(βV₁−V₂), wherein α and β are constants, V₁ is the first resistivity measurement, and V₂ is the second resistivity measurement.

29. A system for estimating an anisotropic resistivity ratio of an anisotropic formation, comprising a computer having a memory storing a program having instructions for:
acquiring a first resistivity measurement by energizing a first transmitter and receiving a first signal in a first receiver, wherein the first transmitter and the first receiver are disposed on the logging tool in a first orientation substantially parallel to a longitudinal axis of the logging tool;
acquiring a second resistivity measurement by energizing a second transmitter and receiving a second signal in a second receiver, wherein the second transmitter and the second receiver are disposed on the logging tool in a second orientation that is substantially orthogonal to the first orientation; and
deriving the anisotropic resistivity ratio from a ratio of the first resistivity measurement and the second resistivity measurement.

30. The system of claim 29, wherein the ratio is V₁/2V₂, where V₁ is the first resistivity measurement and V₂ is the second resistivity measurement.

31. A system for determining a dip angle in a formation having dipping planes, comprising a computer having a memory storing a program having instructions for:
acquiring tri-axial resistivity measurements using a tri-axial logging tool;
deriving an estimate of horizontal resistivity from a difference measurement between two orthogonal sets of measurements derived from the tri-axial measurements; and
determining the dip angle from the tri-axial resistivity measurements and the estimate of horizontal resistivity.

32. A system for determining an electrical property of a formation from tri-axial resistivity measurements acquired with a tri-axial logging tool, comprising a computer having a memory storing a program having instructions for:
obtaining from the tri-axial resistivity measurements a first set of measurements representing couplings between a longitudinal transmitter and a longitudinal receiver;
obtaining from the tri-axial resistivity measurements a second set of measurements representing couplings between a transverse transmitter and a transverse receiver; and
deriving the electrical property of the formation from a difference measurement that is derived from the first set of measurements and the second set of measurements.

33. The system of claim 32, wherein the difference measurement is derived from α(βV₁−V₂), wherein α and β are constants, V₁ is the first set of measurements, and V₂ is the second set of measurements.

34. A system for estimating an anisotropic resistivity ratio of an anisotropic formation from tri-axial resistivity measurements acquired with a tri-axial logging tool, comprising a computer having a memory storing a program having instructions for:
obtaining from the tri-axial resistivity measurements a first set of measurements representing couplings between a longitudinal transmitter and a longitudinal receiver;
obtaining from the tri-axial resistivity measurements a second set of measurements representing couplings between a transverse transmitter and a transverse receiver; and
deriving the anisotropic resistivity ratio from a ratio of the first set of measurements and the second set of measurements.

35. The system of claim 34, wherein the ratio is V₁/2V₂, where V₁ is the first set of measurements and V₂ is the second set of measurements.

36. A system for determining a dip angle in a formation having dipping planes from tri-axial resistivity measurements acquired with a tri-axial logging tool, comprising a computer having a memory storing a program having instructions for:
obtaining from the tri-axial resistivity measurements a first set of measurements representing couplings between a longitudinal transmitter and a longitudinal receiver;
obtaining from the tri-axial resistivity measurements a second set of measurements representing couplings between a transverse transmitter and a transverse receiver; and
deriving an estimate of horizontal resistivity from a difference measurement derived from the first set of measurements and the second set of measurements; and
determining the dip angle from the tri-axial resistivity measurements and the estimate of horizontal resistivity.
